(19) United States
(12) Patent Application Publication
(10) Pub. No.: US 2002/0140180 A1
(43) Pub. Date: Oct. 3, 2002

(54) MICA for exhaust system

(76) Inventors: Hans-Dieter Waltenberg, Staig (DE); Dieter Grafl, Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/005,835

(22) Filed: Nov. 8, 2001

(30) Foreign Application Priority Data
Nov. 9, 2000 (DE) 200 19 051.2

(51) Int. Cl. F16J 15/08

(52) U.S. Cl. 277/627

(57) ABSTRACT

The present invention relates to a gasket for connecting an opening of a first component to a corresponding opening of a second component in a gas-tight fashion. The gasket includes a casing that is at least partially plastically deformable and is filled with a powdery insulating material or a flaky insulating material. The insulation may also be a combination powdery and flaky materials. The invention also relates to a gasket in which two elements of the casing are connected to one another.

The present invention pertains to a gasket according to the preamble of claim 1.

Several gasket variations are known for connecting the openings of two components to one another in a gas-tight fashion. Gaskets are frequently used in the exhaust gas systems of internal combustion engines, e.g., for connecting the engine block to the exhaust gas manifold such that the escape of gas with very high temperatures is prevented.

In one customary variation, a gasket that, for example, has the shape of an annulus is arranged in the region between the components to be connected to one another, wherein said gasket extends around the openings and consists of a metallic wire frame and mineral fillers that are held together with a binder.

Gaskets of this type which are realized in accordance with the prior art have disadvantages in several respects. Because of the binder that is added to the mineral fillers and usually consists of an organic material, gasification of this binder may occur; this represents a certain health risk when the gasified binder is inhaled. In addition, the gasket becomes brittle as the gasification progresses such that its sealing effect is impaired, in particular when the components that contact the gasket are shifted or turned. In addition, gaskets of this type that are realized according to the prior art are ecologically disadvantageous because a gasket that consists of several rigidly connected materials can be separated into its components and recycled only at high expense.

Based on this prior art, the present invention aims to develop a gasket that can be subjected to the same high thermal loads as existing cylinder head gaskets, but does not emit toxic gases due to gasification. In addition, the gasket should flexibly adapt itself to the components to be sealed over extended periods of time, and have superior ecological properties.

This objective is attained with a gasket according to claim 1.

The invention proposes to realize a gasket, according to the preamble of claim 1, in the form of a casing that can be at least partially deformed in a plastic fashion and is filled with powdery and/or flaky insulating material. In this case, the casing that can be at least partially deformed in a plastic fashion ensures that the outer contour of the gasket adapts itself to the intermediate space between the components to be sealed when the gasket is compressed between said components such that the aforementioned intermediate space is filled out. The powdery and/or flaky insulating material that is contained in the interior of the casing and can be displaced ensures that the filling flexibly adapts itself to the design of the outer casing. The powdery or flaky insulating material is held inside the casing due to the fact that the casing is preferably realized in a closed fashion. This makes it possible to eliminate an additional binder, e.g., silicone, such that no gasification of binders can occur under high thermal loads. The ability to withstand high thermal loads can be easily ensured because numerous powdery or flaky insulating materials that can be subjected to high thermal loads are known. This also applies to casing materials that can be partially deformed in a plastic fashion, e.g., metals. In addition, the design according to the invention, in which insulating material that is not chemically bound is arranged within the casing, ensures that the gasket according to the invention can be very easily recycled because its components can be easily separated and subsequently reused.

Advantageous embodiments of the present invention are disclosed in the dependent claims.

According to one particularly advantageous embodiment, mica, expanded graphite, pearlite or a mica decomposition product, e.g., vermiculite, is used as the insulating material. In this respect, vermiculite has particularly advantageous properties. Vermiculite is available in the form of flakes. This flaky consistency provides the advantage that the individual flakes are able to interconnect due to their surface structure, and already form a coherent body of physically interconnected flakes. The formation of such a coherent but still easily deformable “vermiculite block” is particularly advantageous because very small openings in the casing of the gasket do not have to be closed, as would be the case with a liquid filling. This primarily has advantageous effects on the manufacturing costs of the gasket because it may, for example, suffice to simply flange the casing in order to prevent the vermiculite filling from flowing out. The purely inorganic vermiculite which does not gasify even at extremely high temperatures, can be inexpensively obtained. In addition, a gasket filled with vermiculite provides the advantages that vibrations in the exhaust gas system can be dampened, and that an additional reduction in the development of noise is achieved. Naturally, the vermiculite may also be mixed with other insulating materials of the previously described type or contain a filler, e.g., sand. It is also advantageous with respect to the sealing effect and the damping properties of the gasket if the insulating material itself has a certain elasticity as is the case, for example, with mica.

According to another advantageous embodiment, the casing is composed of a least two elements that are positively, integrally and/or nonpositively connected to one another, and consist of a material that can be at least partially deformed in a plastic fashion, preferably metal. As mentioned previously, the casing does not have to be absolutely tight in order to prevent the insulating material from flowing out, such that a less expensive joining method can be utilized in this case. For example, the complementary elements that form the casing may be inserted into one another with a slight press fit, welded to one another, or interconnected by means of hook-like elements. In this respect, it is advantageous to realize the respective elements in a circular fashion, wherein one element should have a cup-shaped cross section in order to easily introduce and hold the insulating material during the manufacturing process.

According to one particularly advantageous embodiment, a casing that has the shape of a hollow cylinder contains, for example, an additional reinforcing ring in the region of its inside diameter wall that serves as a limiter (stopper) for limiting the maximum compressive deformation of the gasket. The stopper may be realized in the form of an additional reinforcing ring, for example, of metal, a flanging of the elements that form the casing, or an additional inner border of metal.

Other advantageous embodiments of the present invention are disclosed in the remaining dependent claims.

The invention is described below with reference to the enclosed figures. The figures show:

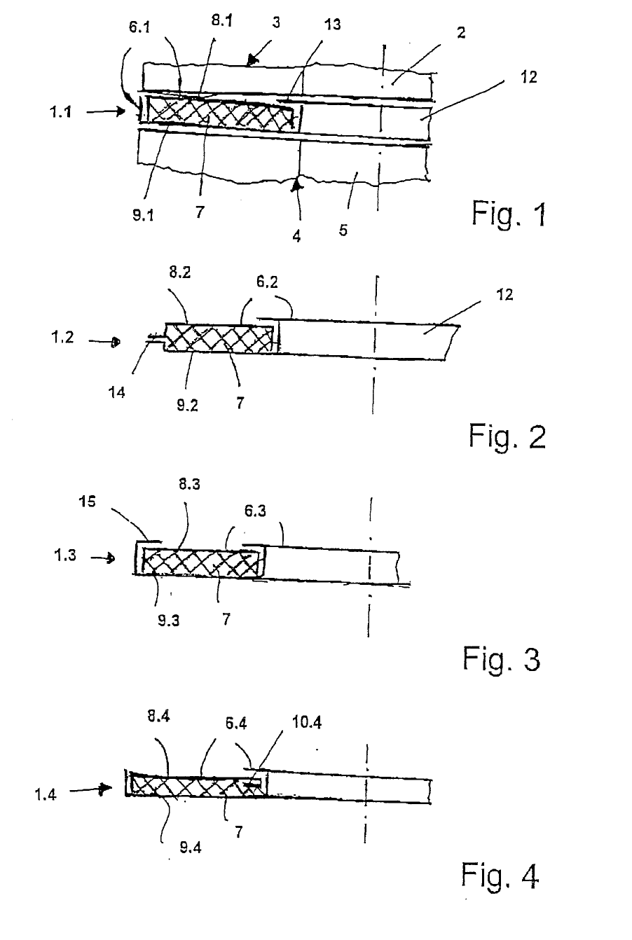

FIG. 1, a gasket according to the invention that is situated between two components that need to be connected to one another in a gas-tight fashion, and

FIGS. 2-7, other embodiments of the gasket according to the invention.

FIG. I shows a gasket 1.1 for connecting the opening 2 of a first component 3 to a corresponding opening 5 of a second component 4 in a gas-tight fashion. The openings 2 and 5 are essentially circular, coincident and aligned relative to one another. The gasket 1.1 is situated in the region between the components 3 and 4. The gasket contains an opening 12 that essentially has the same size as the openings 2 and 5 and is aligned with said openings. The openings 2, 12 and 5 form a gas passage, the tightness of which in the radial direction is ensured by the gasket 1.1. The gasket 1.1 consists of a casing 6.1 that is formed by a cup 8.1 and a carrier 9.1. The cup is filled with vermiculite flakes (filling 7). However, it would also be possible to use mica, expanded graphite, pearlite or another, preferably inorganic, material for the filling. It is advantageous that no organic binder needs to be added to the filling in order to hold the filling together. A sand filler may also be added to the filling.

The carrier 9.1 is essentially realized in the form of a partially open hollow cylinder. The cross section of the hollow cylinder is essentially closed. However, the upper side of the gasket has an open cross section that extends radially outward to the outside diameter wall of the carrier 9.1 at a distance from the inside diameter wall of the opening 12. In this case, only an annulus-shaped web extends radially outward from the inside diameter wall, such that the cup 8.1, which essentially has the shape of an annulus and is realized with a U-shaped cross section, is positively held in the carrier 9.1 . This arrangement provides the advantage that the cup 8.1 can be initially filled with a powdery or flaky filling 7, whereafter the filling is enclosed in the gasket by folding the carrier 9.1.

Holes, not shown in FIG. 1, may be provided in the gasket 1.1 in order to insert screws for pressing together the components 3 and 4. The region around these holes may be designed differently. If a sufficiently rigid filling 7 is provided, it may suffice to merely perforate the cross section shown in FIG. 1. In order to completely prevent the filling from flowing out, the cup or the carrier may be deformed in the region around the opening in such a way that the cup 8.1 and the carrier 9.1 contact one another around the opening, and the casing 6 is closed.

FIG. 2 shows another embodiment of a gasket according to the invention. In the region around the inside wall diameter of the opening 12, this gasket is realized analogously to the variation 1.1. However, the cup 8.2 and the carrier 9.2 are respectively bent outward by 90° at their outer wall, over the entire circumference, in the region of the outside diameter wall of the gasket 1.2. These outwardly bent sections are welded to one another within their contact region 14.

FIG. 3 shows another variation 1.3 of the gasket according to the invention. This gasket is also realized essentially identically to the variation 1.1. However, the variation 1.3 contains an annulus-shaped web 15 in the region of the upper outside diameter wall, wherein said web protrudes radially inward over the cup 8.3. Due to these measures, the cup 8.3 is held more rigidly, and the tightness in the region of the outside diameter wall of the gasket 1.3 is improved.

FIG. 4 shows another modified variation of the gasket 1.1. The gasket 1.4 is essentially realized identically to the gasket 1.1. In the gasket 1.1, the cup has the shape of a U. In the gasket 1.4, the cup is essentially realized in the shape of a “L.” This is achieved in the gasket 1.4 by folding the radially inner limb of the “U” inward into the interior of the cup such that an inner flanged edge 10.4 is produced. This flanged edge provides a support effect in the region of the inner wall, i.e., at the gas passage, and acts as a stopper.

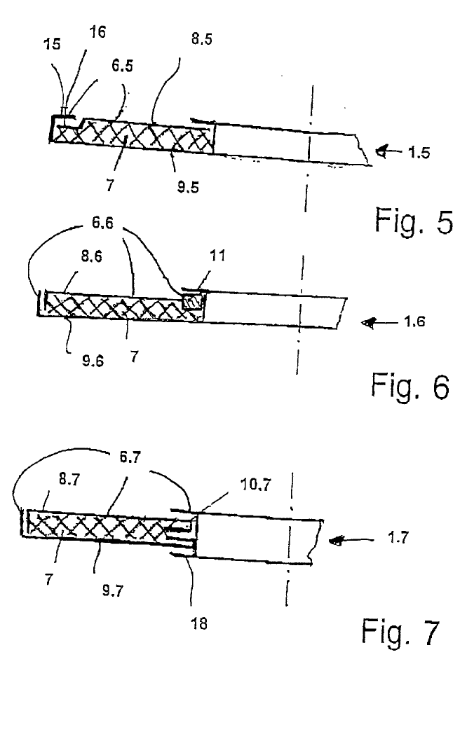

FIG. 5 shows a variation 1.5 which is modified by comparison to the variation 1.3. In this case, a cup with a U-shaped cross section is not provided. The upper open region of the carrier 9.5 is covered with a flat element 8.5 that has the shape of an annulus in this case. This annulus-shaped element contains a half bead 16 in the region of the outside diameter wall of the gasket 1.5, and the radially outer end section of the element 8.5 lies underneath the web 15.

FIG. 6 shows a gasket 1.6 that represents a variation of the gasket 1.1. However, a U-shaped cup 8.1 is not provided in this case. In this gasket, a ring 11 of rectangular cross section is arranged on the element 8.6 in the region of the inside diameter of the gasket 1.6, with said ring serving as a substitute for the inner limb of the “U.” The rectangular ring is encompassed by the carrier 9.6. This ring essentially serves as an incompressible support and as a stopper for the gasket 1.6.

FIG. 7 shows another embodiment of a gasket, namely the variation 1.7. In this case, the carrier 9.7 and the element 8.7 are essentially realized in the shape of a “L.” This L-shape arises by folding inward radically the inside legs 10.7 of starting components having a “U” shape. These “L”-shaped parts are placed on top of one another with their open sides such that the radially outer side wall of the element 8.7 is enclosed by the radially outer wall of the carrier 9.7 over the entire circumference, and a hollow space is formed into which the filling 7 is subsequently introduced. In the region of the inside diameter of the element 8.7 and the carrier of 9.7, these components are respectively held by an inner border 18 of essentially “U”-shaped cross section, wherein said borders respectively extend in the radially outer direction of the gasket 1.7 over the same distance on the upper and the lower side of the gasket.

All the previously described variations of gaskets preferably contain casings that are manufactured from metal. This provides the advantage that the casing is inexpensive and can be easily processed. In addition, metal has the desired property that it can be partially deformed in a plastic fashion.

What is claimed is:

1. Gasket (1) for connecting the opening (2) of a first component (3) to a corresponding opening (5) of a second component (4) in a gas-tight fashion, wherein the gasket essentially extends around these openings in the region between the components, characterized by the fact that the gasket is realized in the form of a casing (6) that can be at least partially deformed in a plastic fashion and is filled with powdery and/or flaky insulating material (7).

2. Gasket according to claim 1, characterized by the fact that the insulating material consists of mica, expanded graphite, pearlite or a mica decomposition product, for example, vermiculite.

3. Gasket according to claim 1, characterized by the fact that the insulating material contains fillers, for example, sand.

4. Gasket according to claim 1, characterized by the fact that the casing (6) consists of at least two elements (8, 9) that are positively, integrally and/or non-positively connected to one another and consist of a material that can be at least partially deformed in a plastic fashion.

5. Gasket according to claim 4, characterized by the fact that the material which can be at least partially deformed in a plastic fashion is a metal.

6. Gasket according to claim 4, characterized by the fact that the elements (8, 9) essentially have the shape of an annulus and a flat or cup-shaped cross section.

7. Gasket according to one of the preceding claims, characterized by the fact that the casing (6) is essentially realized in the shape of a hollow cylinder.

8. Gasket according to claim 7, characterized by the fact that the casing (6) contains a flanged edge (10.4, 10.7) in the region of an inside diameter wall.

9. Gasket according to claim 7, characterized by the fact that the casing (6) contains an additional reinforcing ring (11) in the region of the inside diameter wall.

10. Gasket according to claim 7, characterized by the fact that the casing contains an additional border (18) in the region of the inside diameter.

11. Gasket according to one of the preceding claims, characterized by the fact that the gasket contains holes for inserting screws or the like, wherein the casing is closed in the region around the holes.
